(19) United States
(12) Patent Application Publication
(10) Pub. No.: US 2017/0241451 A1
(43) Pub. Date: Aug. 24, 2017

(54) FLEXURE APPARATUSES, LINEAR ROTARY CONVERTERS, AND SYSTEMS

(71) Applicants: Russell F. JEWETT, Charlotte, NC (US); SENCERA ENERGY, INC., Charlotte, NC (US)

(72) Inventors: Russell F. JEWETT, Charlotte, NC (US); Steven F. PUGH, Charlotte, NC (US)

(21) Appl. No.: 15/322,435

(22) PCT Filed: Jun. 25, 2015
(86) PCT No.: PCT/US15/37839

§ 371 Date: Dec. 27, 2016

Related U.S. Application Data
(60) Provisional application No. 62/016,766, filed on Jun. 25, 2014.

(51) Int. Cl. F15B 15/06; F01B 19/04; F02F 1/18; F04B 43/08; F15B 15/10; F02F 3/00; F16J 3/04; F04B 43/00

(52) U.S. Cl. CPC F15B 15/06; F16J 3/04; F01B 19/04; F04B 43/0072; F04B 43/08; F15B 15/10; F02F 3/0084; F02F 1/18

(57) ABSTRACT

The following description pertains to flexure structures, apparatuses comprising flexure structures, systems comprising flexure structures, methods of using flexure structures, methods of using apparatuses comprising flexure structures, and methods of using systems comprising flexure structures. The following description also pertains to methods, systems, and apparatuses for linear to rotary motion converters.

### CROSS-REFERENCE TO RELATED APPLICATIONS

The present application claims benefit of U.S. Provisional Patent application Ser. No. 62/016,766, entitled “FLEXURE APPARATUSES, FLEXURE SYSTEMS, FLEXURE METHODS, LINEAR ROTARY CONVERTERS, AND SYSTEMS WITH LINEAR ROTARY CONVERTERS,” to Russell F. JEWETT and Steven F. PUGH, filed Jun. 25, 2014 and International Application No. PCT/US2015/037839, titled “FLEXURE APPARATUSES, LINEAR ROTARY CONVERTERS, AND SYSTEMS,” to Russell F. JEWETT and Steven F. PUGH, filed Jun. 25, 2015. The content of U.S. Patent Application Ser. No. 62/016,766, filed Jun. 25, 2015, and the content of International Application No. PCT/US2015/037839, filed Jun. 25, 2015, are incorporated herein, in their entirety, by this reference for all purposes.

### BACKGROUND

One or more aspects of the present invention pertain to flexure structures, linear motion to rotary motion converters, and systems that include flexure structures and/or linear motion to rotary motion converters.

A wide variety of systems include and/or use mechanisms such as bellows structures, diaphragms, and piston/cylinder structures for handling, processing, moving, and using liquids and gases, i.e. fluids. For example, piston/cylinder structures are versatile and can be used for wide ranges of pressure and temperature for operation in numerous types of applications. These types of structures and their applications and uses are covered in the patent and scientific literature. Examples of such literature are U.S. Pat. No. 9,054,139, U.S. Pat. No. 8,431,855, U.S. Pat. No. 8,133,165, U.S. Pat. No. 7,866,953, U.S. Pat. No. 7,832,209, U.S. Pat. No. 7,556,065, U.S. Pat. No. 5,240,385, U.S. Pat. No. 4,655,690, U.S. Pat. No. 4,457,213, U.S. Pat. No. 4,138,973, U.S. Pat. No. 3,131,563, U.S. Pat. No. 2,920,656, Yunus Cengel and Michael Boles, “Thermodynamics: An Engineering Approach,” eight edition, McGraw-Hill, 2014 and Herbert Callen, “Thermodynamics and an Introduction to Thermostatistics,” second edition, John Wiley & Sons, 1985. All of these references are incorporated herein by this reference in their entirety for all purposes.

The present inventors have recognized a need for alternatives to using structures such as bellows structures, diaphragms, piston/cylinder structures in apparatuses and systems in which they are currently used. Furthermore, the present inventors have made one or more discoveries which may overcome one or more deficiencies associated with the use of structures such as bellows structures, diaphragms, and piston/cylinder structures for one or more applications.

### SUMMARY

One aspect of the present invention pertains to a flexure structure. Another aspect of the present invention pertains to systems comprising a flexure structure. Another aspect of the present invention pertains to methods of using flexure structures. Another aspect of the present invention pertains to linear motion to rotary motion converters. Another aspect of the present invention pertains to systems with linear motion to rotary motion converters. Another aspect of the present invention pertains to linear motion to rotary motion converters combined with flexure structures. Another aspect of the present invention pertains to systems with linear motion to rotary motion converters combined with flexure structures. Another aspect of the present invention pertains to linear motion to rotary motion converters combined with bellows structures. Another aspect of the present invention pertains to systems with linear motion to rotary motion converters combined with bellows structures.

It is to be understood that the invention is not limited in its application to the details of construction and to the arrangements of the components set forth in the following description. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is a side view of an embodiment of the present invention.

FIG. 2 is a top view of embodiment of the present invention.

FIG. 3 is a cross-section side view of an embodiment of the present invention.

FIG. 4 is a side view of an embodiment of the present invention.

FIG. 5 is a cross-section side view of an embodiment of the present invention.

FIG. 6 is a cross-section side view of an embodiment of the present invention.

FIG. 7 is a side view of an embodiment of the present invention.

FIG. 7-1 is a cross-section side view of an embodiment of the present invention.

FIG. 8 is a side view of an embodiment of the present invention.

FIG. 8-1 is a cross-section side view of an embodiment of the present invention.

FIG. 9 is a partial cross-section side view of an embodiment of the present invention.

FIG. 9-1 is a partial cross-section side view of an embodiment of the present invention.

FIG. 10 is a partial cross-section side view of an embodiment of the present invention.

FIG. 10-1 is a partial cross-section side view of an embodiment of the present invention.

FIG. 10-2 is a partial cross-section side view of an embodiment of the present invention.

FIG. 10-3 is a partial cross-section side view of an embodiment of the present invention.

FIG. 10-4 is a partial cross-section side view of an embodiment of the present invention.

FIG. 11 is a partial cross-section side view of an embodiment of the present invention.

FIG. 12 is a side view of an embodiment of the present invention.

FIG. 13 is a cross-section side view of an embodiment of the present invention.

FIG. 14 is a diagram of a system according to one embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding embodiments of the present invention.

### Description

In the following description of the figures, identical reference numerals have been used when designating substantially identical elements or processes that are common to the figures.

Unless otherwise defined, all technical and scientific terms used herein have the same meaning as commonly understood by one of ordinary skill in the art to which this invention belongs. In case of conflict with publications, patent applications, patents, and other references mentioned incorporated herein by reference, the present specification, including definitions, will control.

For the following defined terms, these definitions shall be applied, unless a different definition is given in the claims or elsewhere in this specification. All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

The term “horizontal” as used herein is defined as a plane parallel to the plane or surface of a reference surface, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane. The term “on” means there is direct contact among elements.

Various embodiments of the present invention may include any of the described features, alone or in combination. Other features and/or benefits of this disclosure will be apparent from the following description.

The order of execution or performance of the operations or the processes in embodiments of the invention illustrated and described herein is not essential, unless otherwise specified. That is, the operations or the processes may be performed in any order, unless otherwise specified, and embodiments of the invention may include additional or fewer operations or processes than those disclosed herein. For example, it is contemplated that executing or performing a particular operation or process before, contemporaneously with, or after another operation or process is within the scope of aspects of the invention.

Embodiments of the present invention will be discussed below primarily in the context of a class of flexure structures that have the fluid handling properties similar to bellows structures. In other words, these flexure structures can provide a gas or liquid seal, can provide containment of a fluid, can extend or contract along its axis, and can act on or be acted on by a fluid substantially the same as for bellows structures.

Flexure Structures

One or more aspects of the present invention pertain to flexure structures, apparatus comprising flexure structures, systems comprising flexure structures, methods of using apparatus comprising flexure structures, methods of using systems comprising flexure structures, and methods of designing flexure structures.

Numerous systems and apparatuses include and/or use mechanisms such as bellows structures, diaphragms, piston/cylinder structures and for handling and using fluids. These types of mechanisms may have various advantages and disadvantages for various applications. Piston/cylinder structures have the disadvantage of usually requiring lubrication or some other mechanism to reduce the amount of friction and wear between the piston and the walls of the cylinder. Typically, bellows structures and diaphragms require no lubrication, but they are not suitable for high differential pressure operation required for some applications. For high-pressure operations (such as those found in typical thermal cycle engines or fluid-cycle refrigeration systems), typical bellows structures and diaphragms are subjected to stresses than can exceed their elastic strain limit for even very strong and/or flexible materials. Exceeding the elastic strain limit can lead to plastic deformation and failure of the bellows structures and diaphragms.

One or more embodiments of the present invention pertain to a flexure structure that can withstand large pressure differences between the inside and outside of the flexure structure. More specifically, according to one or more embodiments of the present invention, the flexure structure does not require lubrication as required for piston/cylinder structures and is not subject to plastic deformation that can result from operating at differential pressures typical for the operation of engines and fluid cycle refrigeration systems which use piston/cylinder structures.

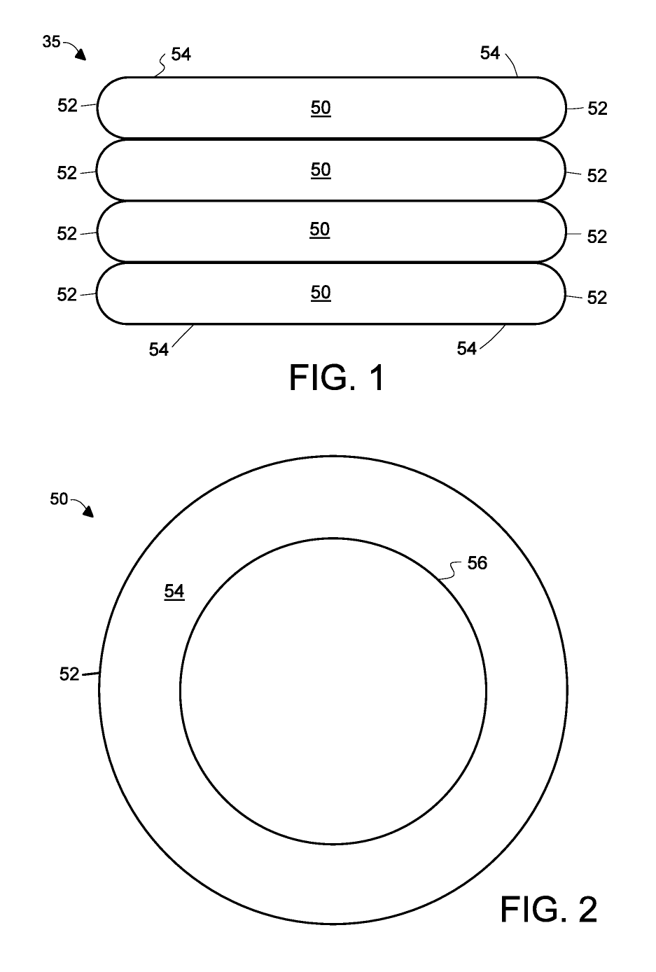

Reference is now made to FIG. 1 where there is illustrated a side view of a flexure structure 35 according to one embodiment of the present invention. Flexure structure 35 comprises a plurality of hollow disk-like convolutions 50. Each of the hollow disk-like convolutions 50 has a periphery 52 that is curved. In other words, the outer edge of hollow disk-like convolutions 50 is curved. Hollow disk-like convolutions 50 have sides 54 that have at least a substantially flat section. Sides 54 of the hollow disk-like convolutions 50 have a hole 56 (hole 56 is not shown in FIG. 1). The plurality of hollow disk-like convolutions 50 are stacked substantially as though they are aligned about an axis. Adjacent hollow disk-like convolutions 50 are joined proximate or at the inner radius of the sides 54. In other words, the plurality of hollow disk-like convolutions are joined at or near the edge of holes 56. As an alternative, one or more embodiments of the present invention may be designed so that convolutions of the flexure structure are joined at or near the outer radius of the sides or at any location between the inner radius and the outer radius of sides 54. More generally, the convolutions are joined such as to form fluid tight seals.

Reference is now made to FIG. 2 where there is shown a top view of a flexure structure 35, according to one embodiment of the present invention, that is substantially the same as that described in FIG. 1. The top view of flexure structure 35 is substantially one side of hollow disk-like structure 50. More specifically, FIG. 2 shows side 54 of hollow disk-like convolution 50 and a portion of periphery of hollow disk-like convolution 52 visible in top view. Side 54 of hollow disk-like convolution 50 has hole 56.

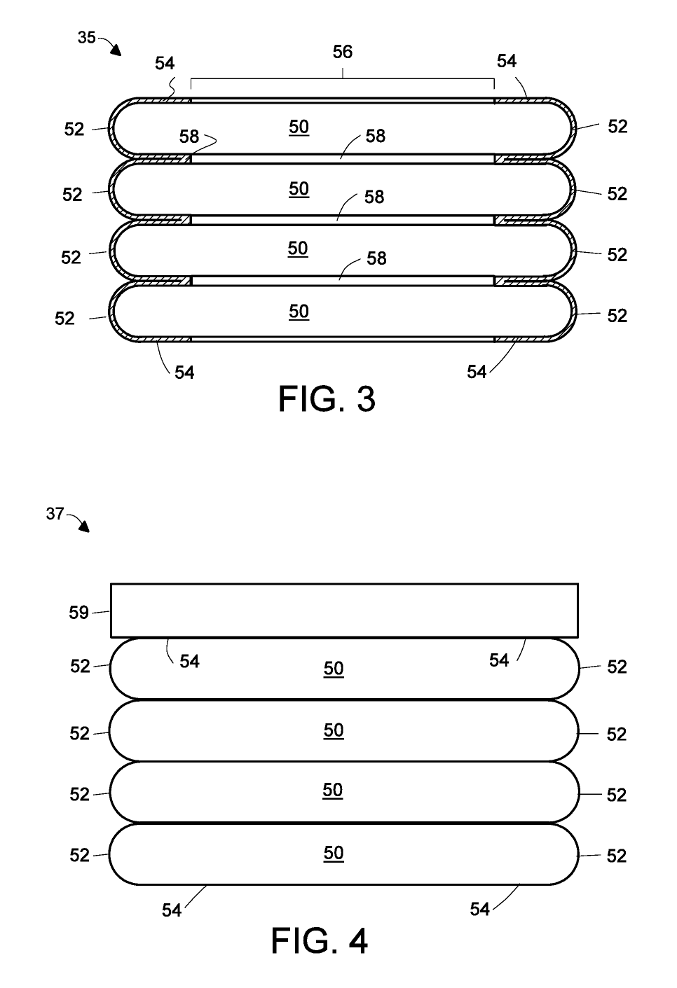

Reference is now made to FIG. 3 where there is shown a cross-section side view of a flexure structure 35 according to one embodiment of the present invention. Flexure structure 35 comprises a plurality of hollow disk-like convolutions 50. Each of the hollow disk-like convolutions 50 has a periphery 52 that is curved; in other words, the outer edge of hollow disk-like convolutions 50 is curved. Hollow disk-like convolutions 50 have sides 54 that have at least a substantially flat section. Sides 54 of the hollow disk-like convolutions 50 have a hole 56. The plurality of hollow disk-like convolutions 50 are stacked substantially as though they are concentrically aligned. Adjacent hollow disk-like convolutions 50 have a connection 58 proximate or at the inner radius of sides 54. In other words, the plurality of hollow disk-like convolutions have a connection 58 at or near the edge of holes 56.

Connection 58 may be a connection such as, but not limited to, a connection formed by welding, formed by an adhesive, formed by fusing, or combinations thereof. Alternatively, connection 58 may be a connection formed by forming a bend in a substantially continuous portion of material of construction of the hollow disk-like convolutions. According to one or more embodiments of the present invention, adjacent hollow disk-like convolutions are arranged so that the sides 54 may be in contact during at least part of their movement for extension and/or contraction of flexure structure 35. In other words, connection 58 may exist while also having part of sides 54 in contact with adjacent sides 54 of hollow disk-like convolutions 50 while flexure structure 35 is relaxed, extended, and/or compressed. According to another embodiment of the present invention, flexure 35 has at least partial contact between adjacent sides 54 of hollow disk-like convolutions 50 while flexure structure 35 is relaxed, extended, and/or compressed.

Reference is now made to FIG. 4 where there is illustrated a side view of a flexure structure 37 according to one embodiment of the present invention. Flexure structure 37 comprises a plurality of hollow disk-like convolutions 50. Each of the hollow disk-like convolutions 50 has a periphery 52 that is curved; in other words, the outer edge of hollow disk-like convolutions 50 is curved. Hollow disk-like convolutions 50 have sides 54 that have at least a substantially flat section. Sides 54 of the hollow disk-like convolutions 50 have a hole 56. The plurality of hollow disk-like convolutions 50 are stacked substantially as though they are concentrically aligned. Adjacent hollow disk-like convolutions 50 are joined proximate or at the inner radius of the sides. In other words, the plurality of hollow disk-like convolutions are joined at or near the edge of holes 56. Flexure structure 37 further comprises an end piece 59.

End piece 59, according to one or more embodiments of the present invention, is substantially rigid and joined at side 54 of one of the hollow disk-like convolutions 50 proximate or at the inner radius of side 54 at an end of the plurality of hollow disk-like convolutions 50. End piece 59 may be joined to side 54 using a connection such as, but not limited to, a connection formed by welding, formed by an adhesive, formed by fusing, and combinations thereof. As an option for one or more embodiments of the present invention, end piece 59 may be shaped as a plate such as a metal plate which may or may not have one or more holes, or end piece 59 may be shaped as a substantially continuous ring. End piece 59 has dimensions so that it is not significantly deformed by the operating conditions for the flexure structure. For or more embodiments of the present invention, end piece 59 is made of a material compatible for joining with the material of the hollow disk-like convolutions and, optionally, may be the same material. Examples of some materials that can be used for end piece 59 include, but are not limited to, metals, metal alloys, steel, stainless steel, titanium, polymers, composite materials, materials used for the flexure structures, and combinations thereof.

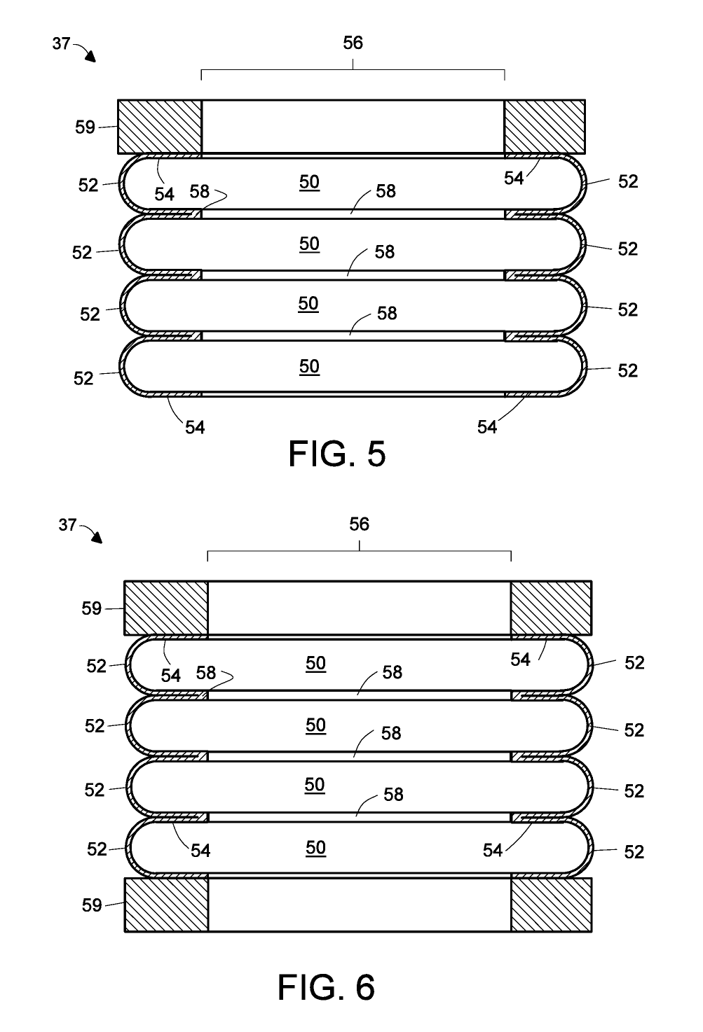

Reference is now made to FIG. 5 where there is shown a cross-section side view of a flexure structure 37 substantially the same as that shown in FIG. 4. According to the embodiment of the present invention shown in FIG. 5, end piece 59 is configured as a substantially continuous ring. Using a ring configuration for end piece 59 can permit fluids to enter or exit the plurality of hollow disk-like convolutions through end piece 59.

Reference is now made to FIG. 6 where there is shown a cross-section side view of a flexure structure 37 substantially the same as that shown in FIG. 5 with the exception that a second end piece 59 is attached to the other end of the plurality of hollow disk-like convolutions 50. More specifically, second end piece 59 is attached to side 54 of the plurality of disk-like convolutions. Second end piece 59 may be joined to side 54 using a connection such as, but not limited to, a connection formed by welding, formed by an adhesive, formed by fusing, and combinations thereof. According to the embodiment of the present invention shown in FIG. 6, each end piece 59 is configured as a substantially continuous ring. Using a ring configuration for end piece 59 can permit fluids to enter or exit the plurality of hollow disk-like convolutions through end pieces 59.

The curvature of the periphery of the hollow disk-like convolutions may be varied for one or more embodiments of the present invention. According to one embodiment of the present invention, the curvature of the periphery corresponds to the curvature of a partial circle such as a semi circular or a smaller portion of a circle. According to one embodiment of the present invention, the curvature of the periphery corresponds to the curvature of a partial ellipse such as a semi elliptical or a smaller portion of an ellipse. According to one embodiment of the present invention, the curvature of the periphery corresponds to the curvature of a partial parabola such as the closed end of a parabola.

The optimum curvature of the periphery of the hollow disk-like convolutions may depend on factors such as the material of construction of the flexure structure, the temperature range for use of the flexure structure, the pressure range for use of the flexure structure. In view of the present disclosure, persons of ordinary skill in the art will be able to derive suitable curvatures for flexure structures according to embodiments of the present invention using conventional optimization techniques.

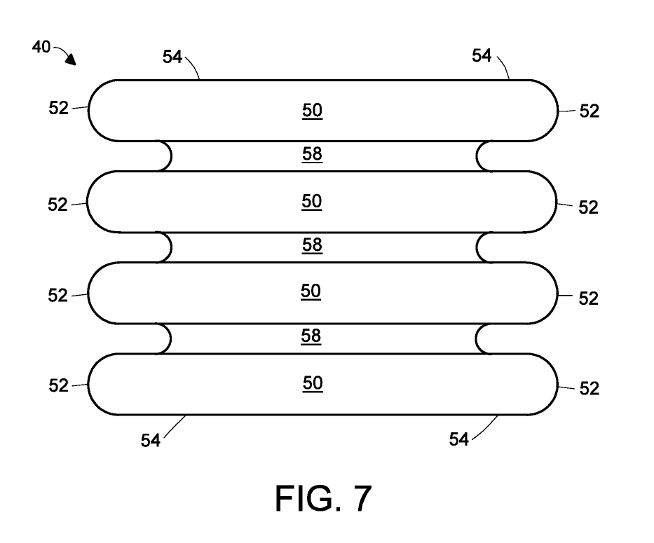

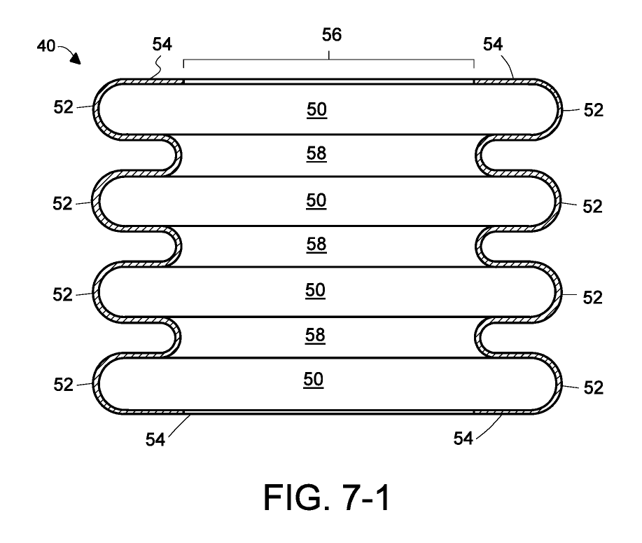

Reference is now made to FIG. 7 where there is shown a side view of the walls for a flexure structure 40 and FIG. 7-1 where there is shown a cross-section side view of the walls for a flexure structure 40. Flexure structure 40 comprises a plurality of hollow disk-like convolutions 50. The periphery 52 of the hollow disk-like convolutions 50 is curved. Hollow disk-like convolutions 50 have sides 54 that comprise a substantially flat portion that connects with an inner curved portion 58 proximate the inner radius of the sides to join the adjacent hollow disk-like convolutions 50. According to one or more embodiments of the present invention, the plurality of hollow disk-like convolutions 50 are stacked. Flexure structure 40 further comprises a restriction ring (restriction ring not shown in FIG. 7 and FIG. 7-1) snugly disposed around each of the inner curved portion 58 of each of hollow disk-like convolutions 50.

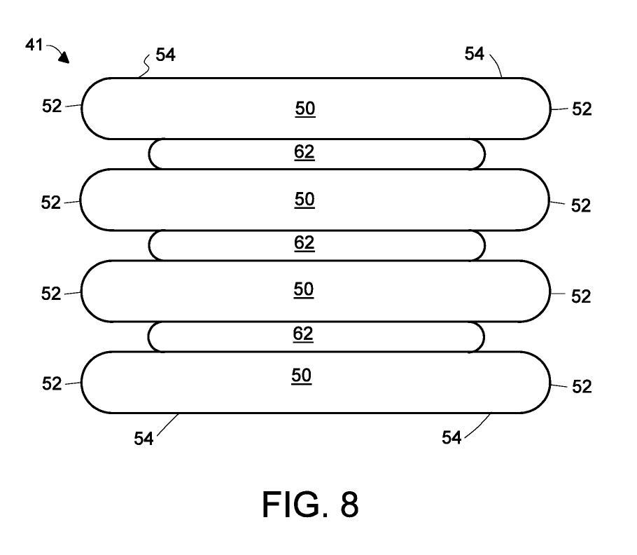

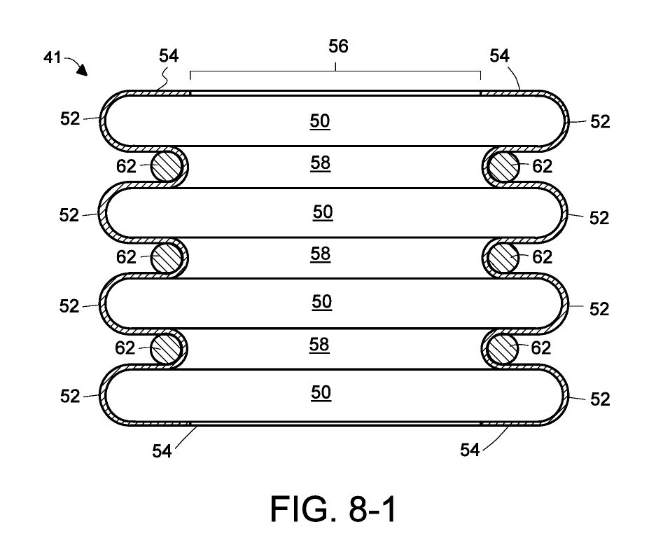

Reference is now made to FIG. 8 where there is shown a side view of a flexure structure 41 that is essentially the same as flexure structure 40 shown in FIG. 7 with the exception of further including restriction rings 62 snugly disposed around each of the inner curved portion 58 of each of hollow disk-like convolutions 50. FIG. 8-1 shows a cross-section side view of flexure structure 41.

According to one or more embodiments of the present invention, the dimensions of the inner curved portion 58 are a function of the difference between the maximum and minimum length variation desired for the flexure structure. According to one or more embodiments of the present invention, the dimensions of the hollow disk-like convolutions 50 are a function of the operating pressure range and/or the operating temperature range of the flexure structure.

According to one or more embodiments of the present invention, restriction ring 62 has dimensions and a tensile strength to retard expansion of the flexure structure at the inner curved portion 58 of the flexure structure. More specifically, restriction ring 62 is constructed and placed so as to substantially retard or prevent radial plastic deformation of the flexure structure. A variety of materials may be used for restriction ring 62. Examples of some materials that can be used for restriction ring 62 include, but are not limited to, metals, metal alloys, steel, stainless steel, titanium, polymers, composite materials, materials used for the flexure structures, and combinations thereof.

It is to be noted that flexure structures illustrated in FIGS. 1 to 8-1 are merely exemplary. One or more embodiments of the present invention may use more than four hollow disk-like convolutions or may use fewer than four hollow disk-like convolutions for the flexure structure.

Flexure structures according to embodiments of the present invention such as, but not limited to, the embodiments shown in and described above for FIGS. 1 to 8-1, can be manufactured using a variety techniques. Manufacturing techniques such as those used for making conventional bellows structures such as, but not limited to, hydroforming, casting, metal plating, welding, injection molding, melting, chemical precipitation, fusing, chemically bonding, three-dimensional printing, and combinations thereof can be used to make one or more embodiments of flexure structures according to the present invention.

A variety of materials can be used for manufacturing flexure structures according to one or more embodiments of the present invention. According to one or more embodiments of the present invention, the flexure structures may comprise materials such as, but not limited to plastic or polymer sheet, rubber sheet, metallic sheet. According to one or more embodiments of the present invention, the plurality of hollow disk-like convolutions are formed from metal sheet or metal alloy sheet. According to one or more embodiments of the present invention, the plurality of hollow disk-like convolutions comprise steel or stainless steel. According to one or more embodiments of the present invention, the plurality of hollow disk-like convolutions comprise titanium alloy. According to one or more embodiments of the present invention, the plurality of hollow disk-like convolutions comprise aluminum, copper, chromium, cobalt, iridium, magnesium, molybdenum, nickel, osmium, rhodium, ruthenium, tantalum, zinc, metal alloys, or combinations thereof.

Computer Modeling Results

Computer models of one or more embodiments of the present invention have been developed. The software modeling was accomplished using one or more software programs such as SolidWorks made by Dassault Systems SolidWorks Corporation, 175 Wyman Street, Waltham, Mass. 02451. It is to be understood that the computer modeling could have been accomplished using software programs other than SolidWorks. Some details of the SolidWorks program can be found in “An Introduction to Stress Analysis Applications with Solid Works Simulation, Student Guide” which is available from Dassault Systems SolidWorks Corporation. The models were used to calculate the yield strength for flexure structures according to one or more embodiments of the present invention. For one or more embodiment of the invention, an appropriate flexure geometry for one or more configurations was determined by modeling the flexure structure by finite element analysis.

A model was created for a flexure structure according to an embodiment of the present invention such as flexure structure 37 shown in FIG. 6. More specifically, a finite element analysis of the stresses experienced by the flexure structure was done to determine a stress profile for the flexure structure. The modeling program was SolidWorks and the flexure structure material was selected to be stainless steel. A static von Mises profile was generated for a computer model image of a section of the flexure structure. The stress profile for the flexure structure was derived for the flexure structure having an internal pressure 45 atmospheres and +6 millimeter of extension along the axial length of the flexure structure. The flexure structure for the computer modeling can flex over a range exceeding −2.5% to +15% of its relaxed length without exceeding the yield limit for the stainless steel used for the modeling, all while maintaining the 45 atmospheres of differential pressure (i.e., difference between the pressure inside the flexure and the pressure outside the flexure). The yield strength of the stainless steel used for the modeling was 931 megapascals. The maximum stress for the flexure structure derived by the model was 757 megapascals which is well below the yield stress for the stainless steel.

Additional computer modeling of the flexure structure like that shown in FIG. 6 was performed. The modeling shows that the flexure structure can be scaled up for use with a pressure differential of more than 350 atmospheres without exceeding the yield strength for stainless steel.

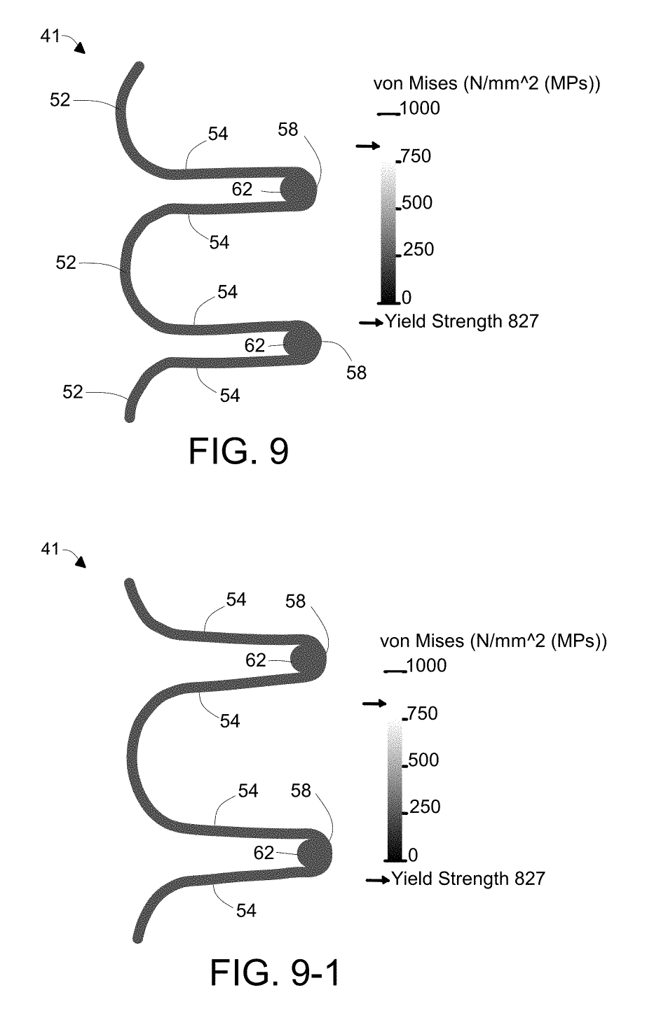

Reference is now made to FIGS. 9 and 9-1 where there is shown a static von Mises profile generated as a computer model image of a section of a flexure structure 41 according to one embodiment of the present invention. Flexure structure 41 is modeled as a material having a yield strength of 827 megapascals. FIG. 9 models flexure structure 41 when it is not extended, in other words, in a relaxed state. FIG. 9-1 shows a static von Mises profile generated as a computer model image of a section of a flexure structure 41 flexure structure 41 when it is in an extended state. The design and dimensions of flexure structure 41 are derived so that mechanical compression and expansion of flexure structure 41 can be sustained with a high differential pressure without exceeding the yield strength of the flexure structure. FIGS. 9 and 9-1 show the stresses in the flexure in the relaxed state and in the extended state of a mechanical cycle of flexure structure 41 with an internal pressure of 4.5 MPa.

Another aspect of the present invention comprises a method of obtaining a flexure structure design. According to one or more embodiments of the present invention, the method comprises specifying a material of construction and its yield strength data; specifying design parameters for a plurality of hollow disk-like convolutions of the material. The periphery of the hollow disk-like convolutions is curved. The sides of the hollow disk-like convolutions are substantially flat and have a hole. The adjacent hollow disk-like convolutions are joined proximate or at the inner radius of the sides. The method also includes iteratively adjusting one or more of the design parameters until all values of the stress profile for the plurality of hollow disk-like convolutions are less than the yield stress for the material of construction. According to one or more embodiments of the present invention, the method is carried out using a software-modeling program such as, but not limited to, a finite element analysis software program.

According to one or more embodiments of the present invention, the method comprises specifying an initial material of construction and acquiring yield stress data for the material. The method also includes specifying an initial shape, an initial size, and/or initial dimensions for a plurality of hollow disk-like convolutions of the material. The periphery of the hollow disk-like convolutions are curved. The sides of the hollow disk-like convolutions have at least a substantially flat section, and the sides of the hollow disk-like convolutions have a hole. The adjacent hollow disk-like convolutions are joined proximate or at the inner radius of the sides. The method also comprises specifying one or more operating conditions for the flexure structure. Examples of operating conditions that may be used include, but are not limited to, temperature, pressure, pressure differential, ambient or exposure gas composition, and combinations thereof. The method also includes specifying at least one performance parameter for the plurality of hollow disk-like convolutions of the material. Examples of performance parameters that might be used may include, but are not limited to, the amount of extension compared to the relaxed state, the amount of compression compared to the relaxed state, usable differential pressure range, and combinations thereof. The method further includes obtaining a stress profile for the plurality of hollow disk-like convolutions using one or more of the inputs the initial specified material of construction; the initial specified shape, initial size, and/or initial dimensions for the plurality of hollow disk-like convolutions; the specified operating conditions; and/or the specified at least one performance parameter. The method includes determining if all values of the stress profile are less than the yield stress for the initial specified material, if so then using the initial specified material of construction; the initial specified shape, the initial size, and/or the initial dimensions for the plurality of hollow disk-like convolutions as the flexure structure design. If all values of the stress profile are not less than the yield stress for the initial specified material, then the method further includes iteratively adjusting one or more of the inputs, such as but not limited to, the specified material of construction; the specified shape, size, and/or dimensions for the plurality of hollow disk-like convolutions; the specified operating conditions; and the specified at least one performance parameter until all values of the stress profile for the plurality of hollow disk-like convolutions are less than the yield stress for the material of construction, then using the material of construction; the shape, size, and/or dimensions for the plurality of hollow disk-like convolutions that provide the stress profile with all values less than the yield stress as the flexure structure design.

Flexure structures according to one or more embodiments of the present invention have a stress profile, during operation at elevated differential pressure, that is below the yield strength of the material of construction of the flexure structure. For one or more embodiments of the present invention, the flexure structures have each value of their stress profile, during operation at elevated differential pressure, below the yield strength of the material of construction of the flexure structure. For one or more embodiments of the present invention, the flexure structures have each value of their stress profile for predetermined operating conditions of the flexure structure below the yield strength of the material of construction of the flexure structure at all points on the flexure structure. For one or more embodiments of the present invention, the flexure structures have each value of their stress profile during operation between 1% to 99% and all values, ranges, and subranges subsumed therein of the yield strength of the material of construction of the flexure structure. For one or more embodiments of the present invention, the flexure structures have a von Mises stress profile during operation below the yield strength of the material of construction of the flexure structure.

Another aspect of the present invention comprises a method of displacing a volume of fluid. According to one embodiment of the present invention, the method comprises providing one or more hollow disk-like convolutions. The periphery of the hollow disk-like convolutions is curved. The sides of the hollow disk-like convolutions are substantially flat and have a hole. The adjacent hollow disk-like convolutions are joined near or at the edge of the sides or may have portions of their sides in contact with adjacent sides. As an option, the method may use flexure structures substantially the same as those described above for FIGS. 1 to 6, 7, 7-1, 8, 8-1,9, and 9-1. The method further includes cyclically increasing or decreasing the volume of the one or more hollow disk-like convolutions.

Another embodiment of the present invention comprises a linear actuator. The linear actuator comprises one or more hollow disk-like convolutions. The periphery of the hollow disk-like convolutions is curved. The sides of the hollow disk-like convolutions have a hole. When there is a plurality of hollow disk-like convolutions, they may be coaxially stacked such as axially aligned. The adjacent hollow disk-like convolutions are joined at the sides or have portions of their sides in contact with adjacent sides, whereby pressure differentials applied to the interior of the hollow disk-like convolutions produces motion substantially along the axis of the hollow disk-like convolutions.

Another aspect of the present invention pertains to systems that include flexure structures as taught in the present disclosure. One embodiment of the present invention is a fluid pump comprising a flexure structure such as the flexure structures described supra and shown in FIGS. 1-6. According to one or more embodiments of the present invention, the flexure structure replaces one or more piston/cylinder structures, bellows structures, or diaphragms of standard technology fluid pumps.

One embodiment of the present invention is a fluid meter comprising a flexure structure such as the flexure structures described supra and shown in FIGS. 1 to 6, 7, 7-1, 8, 8-1, 9, and 9-1.

One embodiment of the present invention is a fluid dispenser comprising a flexure structure such as the flexure structures described supra and shown in FIGS. 1 to 6, 7, 7-1, 8, 8-1, 9, and 9-1.

One embodiment of the present invention is a fluid flow controller comprising a flexure structure such as the flexure structures described supra and shown in FIGS. 1 to 6, 7, 7-1, 8, 8-1, 9, and 9-1. The fluid flow controller further comprises a pressure sensor to measure the pressure of the fluid, and a temperature sensor to measure the temperature of the fluid.

One embodiment of the present invention is an internal combustion engine comprising a flexure structure such as the flexure structures described supra and shown in FIGS. 1 to 6, 7, 7-1, 8, 8-1, 9, and 9-1. According to one embodiment of the present invention, the generation of pressure differentials in the bellows such as by the internal combustion process produces linear motion.

One embodiment of the present invention is a heat engine comprising a flexure structure such as the flexure structures described supra and shown in FIGS. 1 to 6, 7, 7-1, 8, 8-1, 9, and 9-1. According to one embodiment of the present invention, alternately heating and cooling a gas causes the flexure structure to expand or contract to produce linear motion.

One embodiment of the present invention is a heat engine comprising a flexure structure such as the flexure structures described supra and shown in FIGS. 1 to 6, 7, 7-1, 8, 8-1, 9, and 9-1. According to one embodiment of the present invention, the heat engine further comprises components to effect energy conversion using a Brayton cycle, a Rankine cycle, or a Stirling cycle to convert thermal energy into mechanical energy.

One embodiment of the present invention is a heat pump comprising a flexure structure such as the flexure structures described supra and shown in FIGS. 1 to 6, 7, 7-1, 8, 8-1, 9, and 9-1. According to one embodiment of the present invention, the heat pump further comprises components to effect heating or cooling of a load through application of mechanical energy in a Brayton cycle, a Rankine cycle, or a Stirling cycle.

One embodiment of the present invention is a heat pump comprising a flexure structure such as the flexure structures described supra and shown in FIGS. 1 to 6, 7, 7-1, 8, 8-1, 9, and 9-1. According to one embodiment of the present invention, the heat pump further comprises components to effect heating or cooling of a load through application of mechanical energy in a gas cycle or a gas/liquid cycle. One or more embodiments of the present invention comprise a heat pump in which flexure structures such as those described above and in FIGS. 1 to 6, 7, 7-1, 8, 8-1, 9, and 9-1 are used to replace bellows, diaphragms, piston/cylinder structures used in conventional heat pumps.

One embodiment of the present invention is a vacuum pump comprising a flexure structure such as the flexure structures described supra and shown in FIGS. 1 to 6, 7, 7-1, 8, 8-1, 9, and 9-1. According to one embodiment of the present invention, the vacuum pump further comprises components to effect expulsion of fluid from a chamber through application of mechanical energy to the flexure structure. One or more embodiments of the present invention comprise a vacuum pump in which flexure structures such as those described above and in FIGS. 1 to 6, 7, 7-1, 8, 8-1, 9, and 9-1 are used to replace bellows, diaphragms, piston/cylinder structures used in conventional vacuum pumps.

Another embodiment of the present invention comprises using a flexure structure such as the flexure structures described supra and shown in FIGS. 1 to 6, 7, 7-1, 8, 8-1,9, and 9-1 with fuel/oxidizer mixtures (such as gasoline and air) to derive power from the energy released during ignition comparable to a 4-cycle internal combustion piston engine. One or more embodiments of the present invention comprise a 4 cycle internal combustion engine in which flexure structures such as those described above and in FIGS. 1 to 6, 7, 7-1, 8, 8-1,9, and 9-1 are used to replace piston/cylinder structures used in conventional 4-cycle internal combustion engines.

Another embodiment of the present invention comprises using a flexure structure such as the flexure structures described supra and shown in FIGS. 1 to 6, 7, 7-1, 8, 8-1,9, and 9-1 with a fuel/oxidizer mixture (such as gasoline and air) to derive power from the energy released during ignition comparable to a 2-cycle internal combustion piston engine. One or more embodiments of the present invention comprise a 2 cycle internal combustion engine in which flexure structures such as those described above and in FIGS. 1 to 6, 7, 7-1, 8, 8-1,9, and 9-1 are used to replace piston/cylinder structures used in conventional 2-cycle internal combustion engines.

Another embodiment of the present invention comprises using a flexure structure such as the flexure structures described supra and shown in FIGS. 1 to 6, 7, 7-1, 8, 8-1,9, and 9-1 with fuel/oxidizer mixture (such as diesel fuel and air) to derive power from the energy released during ignition comparable to a diesel internal combustion piston engine. One or more embodiments of the present invention comprise a diesel internal combustion piston engine in which flexure structures such as those described above and in FIGS. 1 to 6, 7, 7-1, 8, 8-1,9, and 9-1 are used to replace piston/cylinder structures used in conventional diesel internal combustion piston engine.

Another embodiment of the present invention comprises using a flexure structure such as the flexure structures described supra and shown in FIGS. 1 to 6, 7, 7-1, 8, 8-1, 9, and 9-1 with a heat source (fuel/oxidizer mixture, the sun or other available external heat source) to derive power from the heat transfer to a cold sink using substantially a Brayton cycle. One or more embodiments of the present invention comprise a system that uses the Brayton cycle in which flexure structures such as those described above and in FIGS. 1 to 6, 7, 7-1, 8, 8-1, 9, and 9-1 are used to replace bellows structures, diaphragms, and/or piston/cylinder structures used in conventional Brayton cycle systems.

Another embodiment of the present invention comprises using a flexure structure such as the flexure structures described supra and shown in FIGS. 1 to 6, 7, 7-1, 8, 8-1, 9, and 9-1 with a heat source (fuel/oxidizer mixture, the sun or available external heat source) to derive power from the heat transfer to a cold sink using substantially a Stirling cycle. One or more embodiments of the present invention comprise a system that uses the Stirling cycle in which flexure structures such as those described above and in FIGS. 1 to 6, 7, 7-1, 8, 8-1, 9, and 9-1 are used to replace bellows structures, diaphragms, and/or piston/cylinder structures used in conventional Stirling cycle systems.

Another embodiment of the present invention comprises using a flexure structure such as the flexure structures described supra and shown in FIGS. 1 to 6, 7, 7-1, 8, 8-1, 9, and 9-1 with a heat source (fuel/oxidizer mixture, the sun or available external heat source) to derive power from the heat transfer to a cold sink using substantially a Rankine cycle. One or more embodiments of the present invention comprise a system that uses the Rankine cycle in which flexure structures such as those described above and in FIGS. 1 to 6, 7, 7-1, 8, 8-1, 9, and 9-1 are used to replace bellows structures, diaphragms, and/or piston/cylinder structures used in conventional Rankine cycle systems.

Another embodiment of the present invention comprises using a flexure structure such as the flexure structures described supra and shown in FIGS. 1 to 6, 7, 7-1, 8, 8-1, 9, and 9-1 with a heat source (fuel/oxidizer mixture, the sun or available external heat source) to derive power from the heat transfer to a cold sink using a gas cycle or a gas/liquid cycle (including a phase change).

Another embodiment of the present invention comprises using a flexure structure such as the flexure structures described supra and shown in FIGS. 1 to 6, 7, 7-1, 8, 8-1, 9, and 9-1 with a rotary source of power to pump heat from a cold source to a warm sink using a Rankine cycle.

Another embodiment of the present invention comprises using a flexure structure such as the flexure structures described supra and shown in FIGS. 1 to 6, 7, 7-1, 8, 8-1, 9, and 9-1 with a rotary source of power to pump heat from a cold source to a warm sink using a Stirling cycle.

Another embodiment of the present invention comprises using a flexure structure such as the flexure structures described supra and shown in FIGS. 1 to 6, 7, 7-1, 8, 8-1, 9, and 9-1 with a rotary source of power to pump heat from a cold source to a warm sink using a Brayton cycle.

Another embodiment of the present invention comprises using a flexure structure such as the flexure structures described supra and shown in FIGS. 1 to 6, 7, 7-1, 8, 8-1, 9, and 9-1 with a rotary source of power to pump heat from a cold source to a warm sink using a gas cycle or a gas/liquid cycle.

Additional background information about systems and/or the operation of systems such as fluid pumps, fluid dispensers, fluid flow controllers, vacuum pumps, linear actuators, internal combustion engines, heat pumps, refrigeration, gas cycles, gas/liquid cycles, Brayton cycle, Rankine cycle, and/or Stirling cycle can be found in the scientific and patent literature. Examples of references containing relevant background information include Yunus Cengel and Michael Boles, “Thermodynamics: An Engineering Approach,” eight edition, McGraw-Hill, 2014 and Herbert Callen, “Thermodynamics and an Introduction to Thermostatistics,” second edition, John Wiley & Sons, 1985. All of these references are incorporated herein by this reference in their entirety for all purposes.

Linear—Rotary Motion Conversion

Another aspect of the present invention pertains to an apparatus that produces rotary motion from the expansion and contraction of flexure structures and/or uses rotary motion for expansion and contraction of flexure structures.

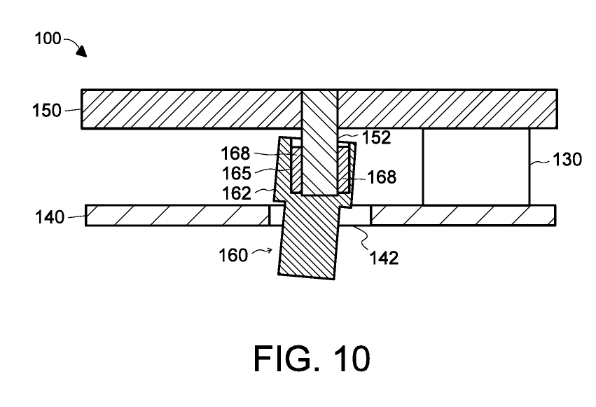

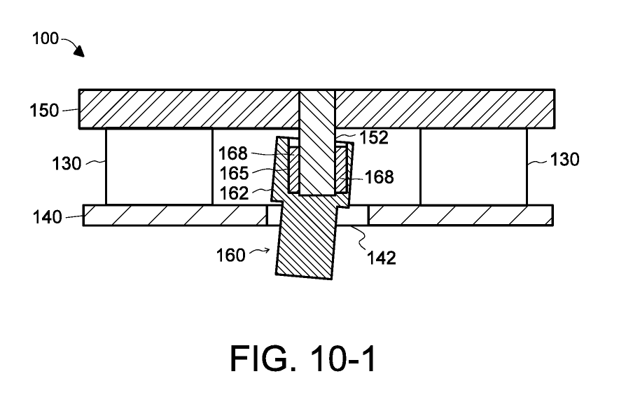

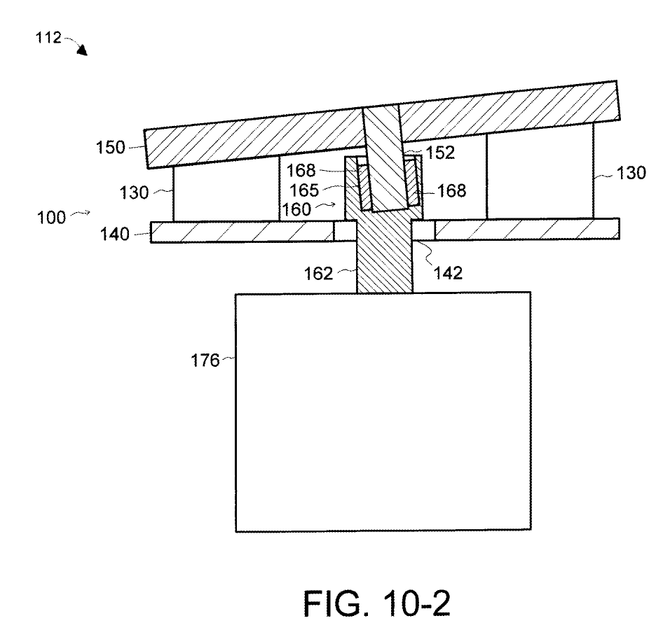

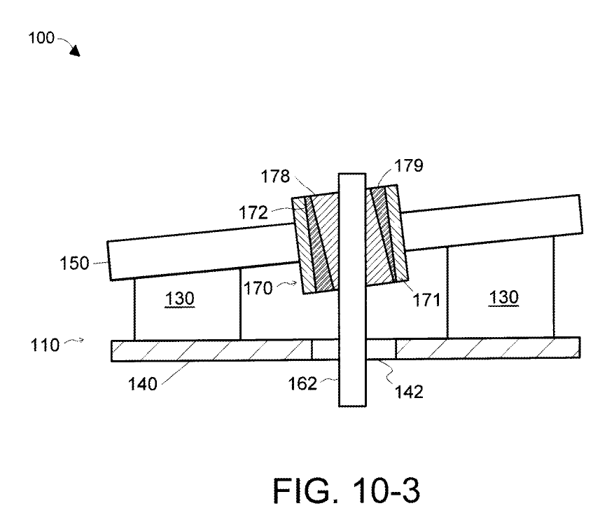

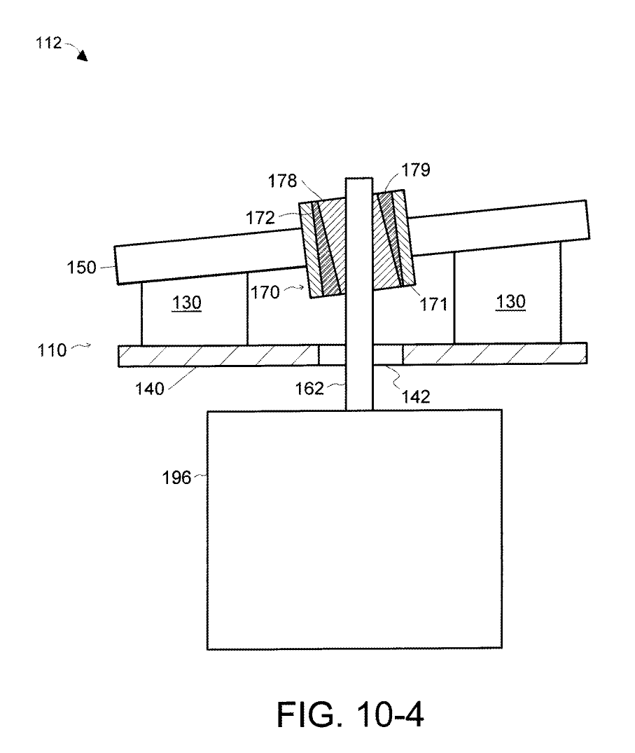

Reference is now made to FIG. 10 where there is shown a diagram of a linear rotary converter 100 according to one or more embodiments of the present invention. Linear rotary converter 100 comprises at least one flexure structure 130 such as any of the embodiments of flexure structures described above, a first port plate 140 which has an opening 142, a nutation rig 150, and a nutation coupling 160 connected with nutation rig 150 through opening 142. The at least one flexure structure 130 is coupled between first port plate 140 and nutation rig 150. The embodiment shown in FIG. 10 also includes a nutation shaft 152. A first end of nutation shaft 152 is connected proximate the center of nutation rig 150; the second end of nutation shaft 152 is connected with nutation coupling 160.

According to one or more embodiments of the present invention, first port plate 140 is substantially rigid and has an area to which one end of flexure structure 130 can be attached so as to form a substantially fluid tight seal such as by welding, soldering, brazing, bolting, adhesive attachment, clamping, or other attachment method or attachment mechanism. Optionally, the fluid tight seal may be accomplished by use of an O-ring, a gasket, or other sealing apparatus. Optionally, the least one flexure structure 130 may include an end piece, such as those described above, for attachment of the least one flexure structure 130 to first port plate 140. According to one or more embodiments of the present invention, first port plate 140 includes one or more ports disposed to allow fluids to enter and/or exit the interior of the at least one flexure structure 130. Optionally, first port plate 140 has one or more ports disposed so as to allow fluid to enter the interior of the least one flexure structure 130 and has one or more ports disposed so as to allow fluid to exit the interior of the least one flexure structure 130.

According to one or more embodiments of the present invention, at least a portion of nutation rig 150 has a substantially planar surface and nutation rig 150 is a substantially rigid. Optionally, nutation rig 150 may be shaped in the form of a plate; optionally the plate may be round or of some other shape. Optionally, nutation rig 150 may be a frame with open areas between the substantially planar surface. The substantially planar surface includes an area to which one end of the least one flexure structure 130 can be attached so as to form a substantially fluid tight seal such as by welding, soldering, brazing, bolting, adhesive attachment, clamping or other attachment method or attachment mechanism. Optionally, the fluid tight seal may be accomplished by use of an O-ring, a gasket, or other sealing apparatus. Optionally, the least one flexure structure 130 may include an end piece, such as those described above, for attachment of the least one flexure structure 130 to nutation rig 150.

The attachment of flexure structure 130 between first port plate 140 and nutation rig 150 prevents rotation of nutation rig 150 while accommodating the nutating oscillations of nutation rig 150 during operation.

According to one or more embodiments of the present invention, nutation coupling 160 comprises a drive shaft 162 having a bore 165 axially offset from the axis of driveshaft 162, and a rotary assembly 168 held in bore 165 arranged so that the second end of nutation shaft 152 is connected with one end of drive shaft 162 by rotary union 168 at an off axis angle. Optionally, rotary assembly 168 may comprise bearings, ball bearings, or other types of rotary mechanisms, According to one embodiment of the present invention the off axis angle is from 1 to 30 degrees. According to one embodiment of the present invention the off axis angle is from 2 to 10 degrees. According to one embodiment of the present invention the off axis angle is 4 degrees.

Alternatively, other types of nutation couplings can be used in one or more embodiments of the present invention. As examples, nutation couplings such as those used to achieve nutation of wobble plates and/or swash plates may be used directly or modified for use in one or more embodiments of the present invention.

FIG. 10 shows an embodiment of the present invention that includes one flexure structure 130. It is to be understood that other embodiments of the present invention may include more than one flexure structure 130 such as two or more flexure structures disposed around the nutation coupling such as shown in FIG. 10-1.

Reference is now made to FIG. 10-2 where there is illustrated a system 112 according to one or more embodiments of the present invention. FIG. 10-2 shows system 112 as a cross-section side view of a partial linear rotary converter substantially the same as linear rotary converter 100 described above coupled with an engine, a motor, or an electricity generator 176. Linear rotary converter 110 shown in FIG. 10-2 includes two or more flexure structures 130 coupled between first port plate 140 and nutation rig 150. Drive shaft 162 of linear rotary converter 100 is coupled with engine, motor, or electricity generator 176. More specifically, drive shaft 162 may be coupled to an engine or coupled to a motor or coupled to an electricity generator according to one or more embodiments of the present invention. The coupling between linear rotary converter 100 and engine, motor, or electricity generator 176 is accomplished so as to allow rotation of drive shaft 162. FIG. 10-2 shows drive shaft 162 disposed so that nutation rig 150 is tilted because of the nutation arrangement. The tilting of nutation rig 150 causes extension or compression of flexure structures 130 depending on their location.

As an option for one embodiment of system 112, the expansion and contraction of flexure structures 130 acting on nutation rig 150 can be used to produce rotation of drive shaft 162 through nutation coupling 160. The expansion and contraction of flexure structures 130 may be accomplished by processes such as, but not limited to, internal combustion processes, cyclical applications of heated gas and cooled gas, and/or cyclical heating and cooling of gas. The rotation of drive shaft 162 may be used to generate electricity when connected with an electricity generator or for other applications that need rotary motion or a rotary drive.

As another option for one embodiment of system 112, the expansion and contraction of flexure structures 130 by way of action from nutation rig 150 can be produced from rotation of drive shaft 162 through nutation coupling 160 when drive shaft 162 is coupled with an engine or electric motor 176. The rotation of drive shaft 162 by engine or electric motor 176 may be accomplished by processes such as, but not limited to, internal combustion processes, electric power, and/or other sources of power provided by or provided to engine or electric motor 176. The expansion and contraction of flexure structures 130 may be used in configurations such as, but not limited to, to pump fluids, to operate fluid-based refrigeration cycles, to compress gases, to evacuate fluids, and to meter fluids.

Alternative embodiments of systems such as system 112 include, but are not limited to: A fluid pump comprising a linear rotary converter as described above. A fluid meter comprising a linear rotary converter as described above. A fluid dispenser comprising a linear rotary converter as described above. A fluid flow controller comprising a linear rotary converter as described above. An internal combustion engine comprising a linear rotary converter as described above. A heat engine comprising a linear rotary converter as described above. A heat pump comprising a linear rotary converter as described above. A vacuum pump comprising a linear rotary converter as described above.

Reference is now made to FIG. 10-3 where there is shown a diagram of a linear rotary converter 100 substantially the same as shown in FIG. 10 and FIG. 10-1 with the exception of having a modified nutation rig and modified nutation coupling replacing the nutation rig and nutation coupling shown in FIG. 10 and FIG. 10-1. More specifically, FIG. 10-3 shows linear rotary converter 100 having a nutation coupling 170 which includes a substantially rigid shell 171 having an axial bore. A drive shaft 162 is disposed through the bore and is held by a rotary coupling 178 having an off-axis axial bore which receives drive shaft 162. Optionally, a second rotary coupling 179 may be disposed around rotary coupling 178. Nutation coupling 170 is configured so that rotation of drive shaft 162 causes nutation of nutation rig 150 to cause compression and expansion of flexure structures 130. Similarly, compression and expansion of flexure structures 130 cause nutation rig 150 and nutation coupling 170 to rotate drive shaft 162.

Reference is now made to FIG. 10-4 where there is shown a diagram of a system 112 substantially the same as shown in FIG. 10-2 with the exception of having a modified nutation rig and modified nutation coupling replacing the nutation rig and nutation coupling shown in FIG. 10-2. More specifically, FIG. 10-4 shows system 112 having a nutation coupling 170 which includes a substantially rigid shell 171 having an axial bore. A drive shaft 162 is disposed through the bore and is held by a rotary coupling 178 having an off-axis axial bore which receives drive shaft 162. Optionally, a second rotary coupling 179 may be disposed around rotary coupling 178. Nutation coupling 170 is configured so that rotation of drive shaft 162 causes nutation of nutation rig 150 to cause compression and expansion of flexure structures 130. Similarly, compression and expansion of flexure structures 130 cause nutation rig 150 and nutation coupling 170 to rotate drive shaft 162.

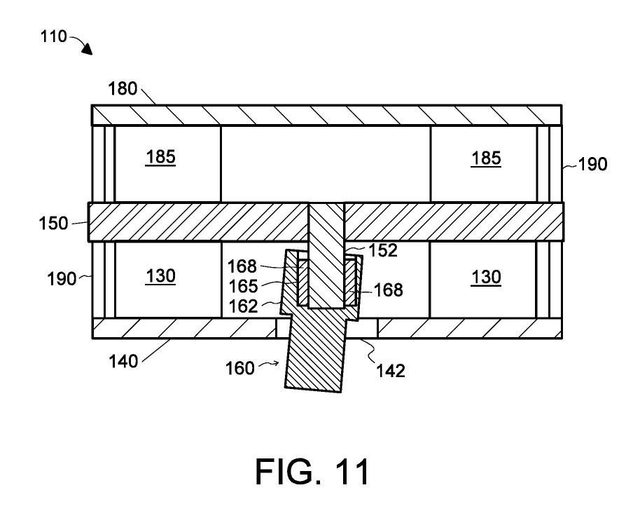

Reference is now made to FIG. 11 where there is shown a cross section side view diagram of a linear rotary converter 110 according to one or more embodiments of the present invention. Linear rotary converter 110 comprises at least one flexure structure 130 such as any of the embodiments of flexure structures described above, a first port plate 140 which has an opening 142, a nutation rig 150, and a nutation coupling 160 connected with nutation rig 150 through opening 142. The at least one flexure structure 130 is coupled between first port plate 140 and nutation rig 150. The embodiment shown in FIG. 11 also includes a nutation shaft 152. A first end of nutation shaft 152 is connected proximate the center of nutation rig 150; the second end of nutation shaft 152 is connected with nutation coupling 160. Rotary converter 110 is essentially the same as rotary converter 100 shown in FIG. 10 but also comprises a second port plate 180, at least one second level flexure structure 185, and one or more port plate connectors 190. The one or more port plate connectors 190 are substantially rigid and are disposed so as to hold second port plate 180 opposite first port plate 140 so as to have nutation rig 150 therebetween. The at least one second level flexure structure 185 is connected between nutation rig 150 and second port plate 180.

According to one or more embodiments of the present invention, second port plate 180 is essentially the same as first port plate 140 described above with the exception that second port plate 180 does not require center hole 142 described for first port plate 140, although a center hole may be present as an option. The at least one second level flexure structure 185 is essentially the same as flexure structure 130 described above. Second level flexure structure 185 is connected between nutation rig 150 and second port plate 180 so that the ends of second level flexure structure 185 have a fluid tight seal to nutation rig 150 on one end and a fluid tight seal to second port plate 180 on the other end. The connection of the at least one second level flexure structure 185 may be accomplished as described above for the connection of the least one flexure structure 130 above.

According to one or more embodiments of the present invention, second port plate 180 includes one or more ports disposed to allow fluids to enter and/or exit the interior of the at least one second level flexure structure 185. Optionally, second port plate 180 has one or more ports disposed so as to allow fluid to enter the interior of the least one-second level flexure structure 185 and has one or more ports disposed so as to allow fluid to exit the interior of the least one-second level flexure structure 185.

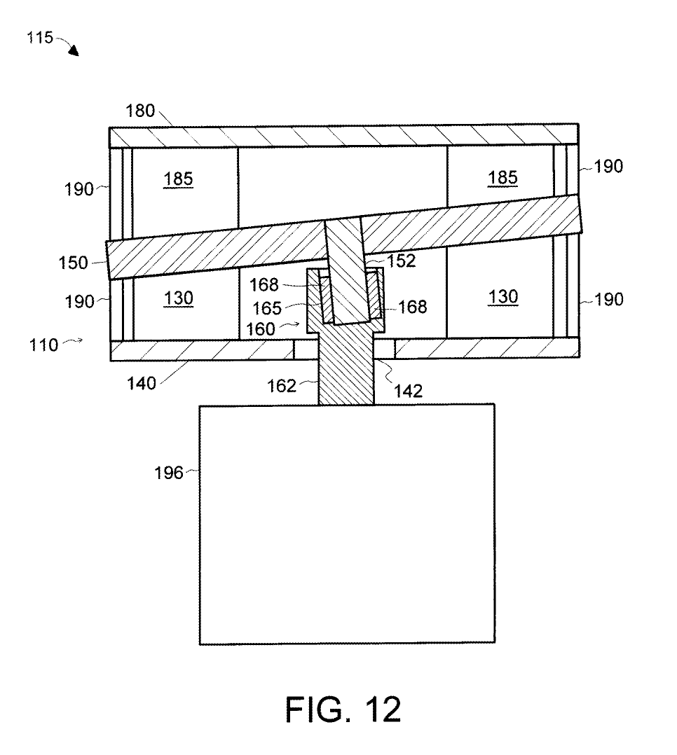

Reference is now made to FIG. 12, where there is illustrated a system 115 according to one or more embodiments of the present invention. FIG. 12 shows system 115 as a cross-section side view a partial linear rotary converter substantially the same as linear rotary converter 110 described above coupled with an engine, a motor, or an electricity generator. Drive shaft 162 of linear rotary converter 110 is coupled with engine, motor, or electricity generator 196. More specifically, drive shaft 162 may be coupled to an engine, coupled to a motor, or coupled to an electricity generator according to one or more embodiments of the present invention. The coupling between linear rotary converter 110 and engine, motor, or electricity generator 196 is accomplished so as to enable rotation of drive shaft 162. FIG. 12 shows drive shaft 162 disposed so that nutation rig 150 is tilted because of the nutation arrangement. The tilting of nutation rig 150 causes extension or compression of flexure structures 185 and 130 depending on their location.

As an option for one or more embodiments of system 115, the expansion and contraction of flexure structures 185 and 130 acting on nutation rig 150 can be used to produce rotation of drive shaft 162 through nutation coupling 160. The expansion and contraction of flexure structures 185 and 130 may be accomplished by processes such as, but not limited to, internal combustion processes, cyclical applications of heated gas and cooled gas, and/or cyclical heating and cooling of gas. The rotation of drive shaft 162 may be used to generate electricity when connected with an electricity generator or for other applications that need rotary motion or a rotary drive.

As another option for one or more embodiments of system 115, the expansion and contraction of flexure structures 185 and 130 by way of action from nutation rig 150 can be produced from rotation of drive shaft 162 through nutation coupling 160 when drive shaft 162 is coupled with an engine or electric motor 196. The rotation of drive shaft 162 by engine or electric motor 196 may be accomplished by processes such as, but not limited to, internal combustion processes, electric power, and/or other sources of power provided by or provided to engine or electric motor 196. The expansion and contraction of flexure structures 185 to 130 may be used in configurations such as, but not limited to, to pump fluids, to operate fluid-based refrigeration cycles, to compress gases, to evacuate fluids, and to meter fluids.

Alternative embodiments of the present invention include, but are not limited to: A fluid pump comprising a linear rotary converter as described above. A fluid meter comprising a linear rotary converter as described above. A fluid dispenser comprising a linear rotary converter as described above. A fluid flow controller comprising a linear rotary converter as described above. An internal combustion engine comprising a linear rotary converter as described above. A heat engine comprising a linear rotary converter as described above. A heat pump comprising a linear rotary converter as described above. A vacuum pump comprising a linear rotary converter as described above.

Another embodiment of the present invention includes a method comprising providing a flexure structure such as any of the flexure structures described above and in FIGS. 1-6, 8, 8-1, 9, and 9-1. The method further comprises providing a fluid to the interior of the flexure structure and cyclically creating a differential pressure exceeding 200 kPa (2 Bar) between the interior and exterior of the flexure structure so as to elongate the flexure structure without exceeding the yield strength of the flexure structure and reducing the pressure within the flexure structure so that the flexure structure contracts. The method may further comprise using the expansion and contraction motion of the flexure structure to create rotary motion. Optionally, the method may comprise using the expansion and contraction motion of the flexure structure to actuate a nutation rig or a wobble plate to create rotary motion.

Another embodiment of the present invention includes a method comprising providing a flexure structure such as flexure structures described above and in FIGS. 1-6, 8, 8-1, 9, and 9-1, providing a fluid to the interior of the flexure structure, and using rotary motion to compress the flexure structure so as to produce a differential pressure between the interior and exterior of the flexure structure exceeding 200 kPa (2 Bar) without exceeding the yield strength of the flexure structure. The method may further comprise expelling the fluid from the flexure structure at a higher pressure. Optionally, the method may comprise using rotary motion to compress the flexure structure by using a nutation rig or a wobble plate to actuate the flexure structure.

Another embodiment of the present invention includes a flexure structure, such as flexure structures described above and in FIGS. 1-6, 8, 8-1, 9, and 9-1, comprising a sidewall that at least partially encloses a volume. The sidewall is shaped so as to operate with a differential pressure exceeding 200 kPa (2 Bar) between the interior and exterior of the volume. The volume is changeable with time so as to interact with a fluid or gas.

One or more embodiments of the present invention include a flexure structure comprising a plurality of hollow disk-like convolutions of a material. The hollow disk-like convolutions have a periphery and two oppositely disposed sides joined by the periphery. The periphery of the hollow disk-like convolutions have a curvature and a portion of the sides of the hollow disk-like convolutions is a substantially flat area. The sides of the hollow disk-like convolutions have a hole defined by an inner radius. The adjacent hollow disk-like convolutions are joined proximate or at the edge of the holes so as to form a fluid tight seal. The flat areas between adjacent hollow disk-like convolutions are in contact.

According to a further embodiment of the present invention, the thickness of the sides of the hollow disk-like convolutions, the yield strength of the material, and/or the size of the flat areas of the sides of the hollow disk-like convolutions are effective to retard or prevent radial plastic deformation of the plurality of hollow disk-like convolutions for operating pressure differentials such as, but not limited to, fluid based refrigeration cycle operating pressure differentials, fluid based thermal engine operating pressure differentials, fluid pump operating pressure differentials, fluid compressors, fluid flow meter operating pressure differentials, internal combustion engine operating pressure differentials, four-stroke gasoline engine operating pressure differentials, two-stroke gasoline engine operating pressure differentials, and diesel engine operating pressure differentials.

According to a further embodiment of the present invention, the thickness of the sides of the hollow disk-like convolutions, the yield strength of the material, and/or the size of the flat areas of the sides of the hollow disk-like convolutions are effective to prevent radial plastic deformation of the plurality of hollow disk-like convolutions for operating pressure differentials of greater than or equal to 200 kPa (2 Bar).

One or more embodiments of the present invention comprise a linear rotary converter substantially as described above with the exception of replacing the flexure structures described above with a bellows structure such as commercially available bellows. According to one embodiment, the linear rotary converter comprises at least one bellows and a first port plate, the first port plate being substantially rigid, the first port plate having an opening. The linear rotary converter further comprises a nutation rig, the nutation rig having a substantially planar surface, the nutation rig being substantially rigid, and a nutation coupling connected with the nutation rig through the opening. The at least one bellows is coupled between the base and the nutation rig substantially as described above for the flexure structure embodiments of the present invention. Optionally, the linear rotary converter may further comprise a second port plate, one or more port plate connectors, and at least one second level bellows, the one or more port plate connectors are substantially rigid, the one or more port plate connectors are disposed so as to hold the second port plate opposite the first port plate having the nutation rig therebetween. The at least one second bellows is connected between the nutation rig and the second port plate.

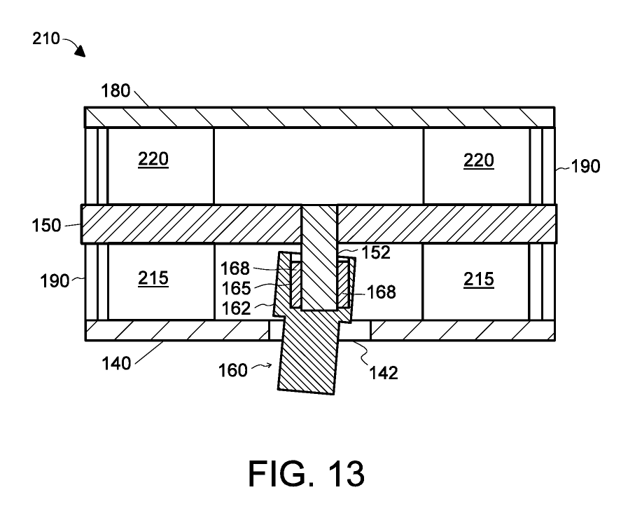

Reference is now made to FIG. 13 where there is illustrated a cross-section side view of a linear rotary converter 210 according to one or more embodiments of the present invention. Linear rotary converter 210 is substantially the same as linear rotary converter 110 shown in FIG. 11 with the exception that linear rotary converter 210 has at least one bellows 215 instead of the at least one flexure structure 130 and has at least one second level bellows 220 instead of the at least one second level flexure structure 185.

A variety of materials can be used for manufacturing linear rotary converters according to one or more embodiments of the present invention. According to one or more embodiments of the present invention, the linear rotary converters comprise steel or stainless steel. According to one or more embodiments of the present invention, the linear rotary converters comprise titanium or titanium alloy. According to one or more embodiments of the present invention, the linear rotary converters comprise aluminum, copper, chromium, cobalt, iridium, magnesium, molybdenum, nickel, osmium, rhodium, ruthenium, tantalum, zinc, metal alloys, or combinations thereof.

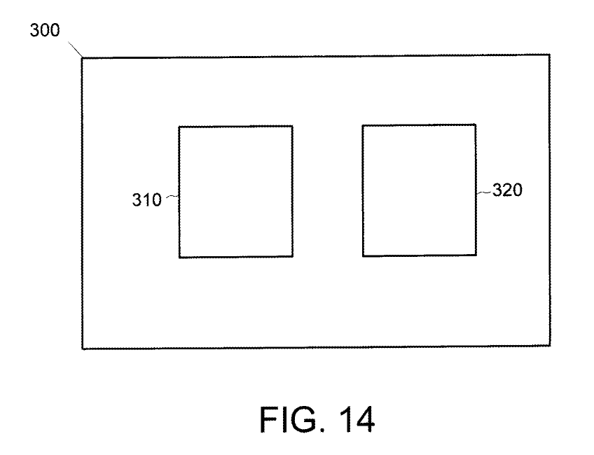

Reference is now made to FIG. 14 which shows a diagram of a system 300 according to one or more embodiments of the present invention. System 300 comprises a flexure structure 310 such as any of the flexure structures described above and in FIGS. 1-6, 8, 8-1, 9, and 9-1 and/or a linear rotary converter 320 such as any of the linear rotary converters described above and in FIGS. 10, 10-1, 10-2, 10-3, 10-4, 11, 12, and 13. System 300 is further characterized as being or having components for a fluid based refrigeration cycle, fluid based thermal engine, fluid pump, fluid compressors, fluid flow meter, internal combustion engine, four-stroke gasoline engine, two-stroke gasoline engine, diesel engine, or electricity generator.

In the foregoing specification, the invention has been described with reference to specific embodiments; however, one of ordinary skill in the art appreciates that various modifications and changes can be made without departing from the scope of the present invention as set forth in the claims below. Accordingly, the specification is to be regarded in an illustrative, rather than a restrictive sense, and all such modifications are intended to be included within the scope of the present invention.

Benefits, other advantages, and solutions to problems have been described above with regard to specific embodiments; however, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

1-28. (canceled)

29. A system comprising:
at least one flexure structure comprising a plurality of hollow disk-like convolutions, the periphery of the hollow disk-like convolutions being curved, the sides of the hollow disk-like convolutions being substantially flat, the sides of the hollow disk-like convolutions having a hole, the adjacent hollow disk-like convolutions being joined;
a first port plate, the first port plate being substantially rigid, the first port plate having a hole;
a nutation rig, the nutation rig having a substantially planar surface, the nutation rig being substantially rigid;
a nutation coupling connected with the nutation rig through the hole; and
the at least one flexure structure being coupled between the first port plate and the nutation rig.

30. The system of claim 29, wherein the at least one flexure structure comprises two or more flexure structures disposed around the nutation coupling.

31. The system of claim 29, wherein the first port plate has one or more ports disposed so as to allow fluid to enter or exit the interior of the at least one flexure structure.

32. The system of claim 29, wherein the first port plate has one or more ports disposed so as to allow fluid to enter the interior of the flexure structure and has one or more ports disposed so as to allow fluid to exit the interior of the flexure structure.

33. The system of claim 29, wherein the nutation coupling comprises a nutation shaft with a first end connected proximate the center of the nutation rig, a drive shaft, and a rotary union arranged so that the second end of the nutation shaft is connected with one end of the drive shaft by the rotary union at an off axis angle.

34. The system of claim 33, wherein the off axis angle is from 1 to 30 degrees.

35. The system of claim 33, wherein the off axis angle is from 2 to 10 degrees.

36. The system of claim 33, wherein the off axis angle is 4 degrees.

37. The system of claim 29, further comprising a second port plate, one or more port plate connectors, and at least one second level flexure structure, the one or more port plate connectors being substantially rigid, the one or more port plate connectors being disposed so as to hold the second port plate opposite the first port plate having the nutation rig therebetween; the at least one second level flexure structure being connected between the nutation rig and the second port plate.

38. The system of claim 33, further comprising an engine, a motor, or an electricity generator coupled to the drive shaft.

39. A fluid pump comprising the system of claim 29.

40. A fluid meter comprising the system of claim 29.

41. A fluid dispenser comprising the system of claim 29.

42. A fluid flow controller comprising the system of claim 29.

43. An internal combustion engine comprising the system of claim 29.

44. A heat engine comprising the system of claim 29.

45. A heat pump comprising the system of claim 29.

46. A vacuum pump comprising the system of claim 29.

47-55. (canceled)

56. A method of obtaining a flexure structure design, the method comprising:
specifying an initial material of construction and acquiring yield stress data for the material;
specifying an initial shape, an initial size, and/or initial dimensions for a plurality of hollow disk-like convolutions of the material, the periphery of the hollow disk-like convolutions being curved, the sides of the hollow disk-like convolutions having a substantially flat section, the sides of the hollow disk-like convolutions having a hole, the adjacent hollow disk-like convolutions being joined proximate or at the inner radius of the sides;
specifying one or more operating conditions for the flexure structure;
specifying at least one performance parameter for the plurality of hollow disk-like convolutions of the material;
obtaining a stress profile for the plurality of hollow disk-like convolutions using one or more of the inputs:
the initial specified material of construction;
the initial specified shape, initial size, and/or initial dimensions for the plurality of hollow disk-like convolutions;
the specified operating conditions; and/or
the specified at least one performance parameter; and
if all values of the stress profile are less than the yield stress for the initial specified material, then using the initial specified material of construction; the initial specified shape, the initial size, and/or the initial dimensions for the plurality of hollow disk-like convolutions as the flexure structure design;
if all values of the stress profile are not less than the yield stress for the initial specified material, then iteratively adjust one or more of the inputs:
the specified material of construction;
the specified shape, size, and/or dimensions for the plurality of hollow disk-like convolutions;
the specified operating conditions; and
the specified at least one performance parameter until all values of the stress profile for the plurality of hollow disk-like convolutions are less than the yield stress for the material of construction, then using the material of construction; the shape, size, and/or dimensions for the plurality of hollow disk-like convolutions that provide the stress profile with all values less than the yield stress as the flexure structure design.

57-58. (canceled)
